(19) United States
(12) Patent Application Publication
(10) Pub. No.: US 2023/0283014 A1
(43) Pub. Date: Sep. 7, 2023

(54) SYSTEMS AND METHODS INVOLVING WIRING CONNECTORS

(71) Applicant: Ford Global Technologies, LLC, Dearborn, MI (US)

(72) Inventors: John Bielawski, Taylor, MI (US); Joel Allen Pittenger, Rochester Hills, MI (US)

(73) Assignee: Ford Global Technologies, LLC, Dearborn, MI (US)

(21) Appl. No.: 17/653,072

(22) Filed: Mar. 1, 2022

(51) Int. Cl. H01R 13/631; H01R 43/26

(52) U.S. Cl. CPC H01R 13/631; H01R 43/26; H01R 2201/26

(57) ABSTRACT

The disclosure generally pertains to systems and methods involving wiring connectors. In an example system, the system may include a first wire having a first connector portion, a second wire having a second connector portion, and a connector position assurance device configured to electrically connect the first wire to the second wire after the first connector portion is mechanically connected to the second connector portion. In an example method, a first connector portion of a first wire may be aligned against a second connector portion of a second wire. The first connector portion may then be moved towards the second connector portion. The first wire may then be electrically connected to the second wire via a connector position assurance device after the first connector portion is mechanically connected to the second connector portion.

### BACKGROUND

Some wiring connectors may not be electrically connected even though the wiring connector may appear to be mechanically connected. These may be caused by completely or partially disconnected wiring connectors. Further, some wiring connectors may be difficult to retrieve once they are placed in a product. For example, multiple components may need to be removed from a vehicle to obtain access to a faulty wiring connector that has already been implemented in a vehicle. This process may be capital-intensive and time-intensive.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIGS. 1A-C illustrates an example wiring connector in accordance with an embodiment of the disclosure.

FIGS. 2A-C illustrates an example wiring connector in accordance with an embodiment of the disclosure.

FIGS. 3A-C illustrates an example wiring connector in accordance with an embodiment of the disclosure.

FIGS. 4A-C illustrates an example wiring connector in accordance with an embodiment of the disclosure.

FIGS. 5A-C illustrates an example wiring connector in accordance with an embodiment of the disclosure.

FIGS. 6A-C illustrates an example wiring connector in accordance with an embodiment of the disclosure.

FIG. 7 depicts a flow chart of an example method for utilizing a wiring connector in accordance with the disclosure.

### DETAILED DESCRIPTION

### Overview

In terms of a general overview, certain embodiments described in this disclosure are directed to systems and methods involving wiring connectors. In an example system, the system may include a first wire having a first connector portion, a second wire having a second connector portion, and a connector position assurance device configured to electrically connect the first wire to the second wire after the first connector portion is mechanically connected to the second connector portion. In an example method, a first connector portion of a first wire may be aligned against a second connector portion of a second wire. The first connector position may then be moved towards the second connector position. The first wire may then be electrically connected to the second wire via a connector position assurance device after the first connector portion is mechanically connected to the second connector portion.

### Illustrative Embodiments

The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular device or component may be performed by another device or component.

Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and phrases are used herein solely for convenience and such words and terms should be interpreted as referring to various objects and actions that are generally understood in various forms and equivalencies by persons of ordinary skill in the art. The word “wire” may be any of various wires that can be found in a vehicle or in other applications.

It must also be understood that words such as “implementation,” “scenario,” “case,” and “situation” as used herein are an abbreviated version of the phrase “in an example (“implementation,” “scenario,” “case,” “approach,” and “situation”) in accordance with the disclosure.” Furthermore, the word “example” as used herein is intended to be non-exclusionary and non-limiting in nature.

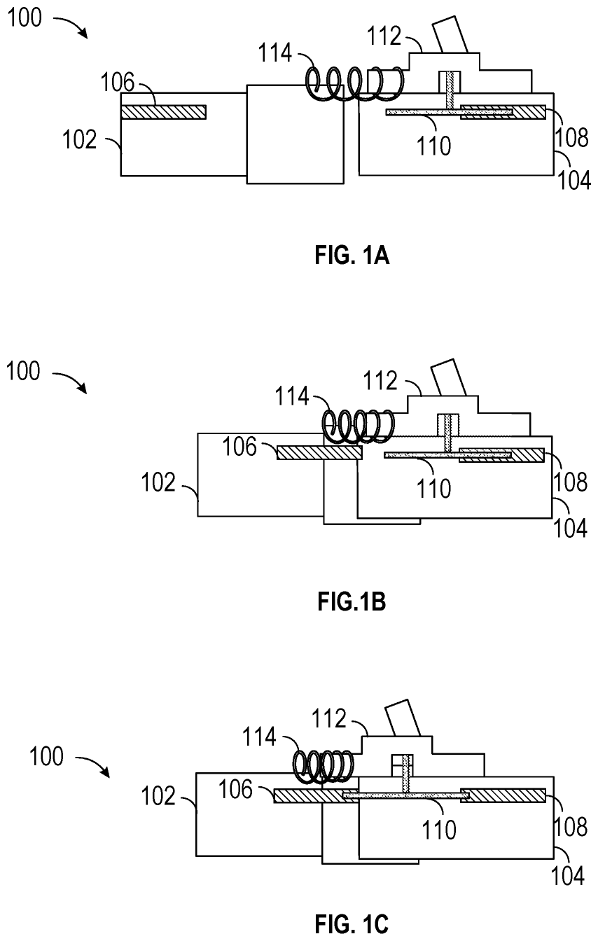

FIGS. 1A-C illustrates an example wiring connector 100 in accordance with an embodiment of the disclosure. In some embodiments, the wiring connector 100 may be a device connector or an inline connector. In some embodiments, the wiring connector 100 may be a sealed connector or an unsealed connector. In some embodiments, the wiring connector 100 may be an automotive connector. As depicted in FIGS. 1A-C, the wiring connector 100 may be an unsealed inline connector. In some embodiments, the unsealed inline connector may use a first female terminal 102 that is configured to be connected to a second male terminal 104. The unsealed inline connector may be enabled by replacing one male blade with a female terminal in a male side connector. As depicted in FIG. 1A, the first female terminal 102 may include a wire terminated female terminal 106. In some embodiments, the first female terminal 102 may be a first connector portion of a first wire. As depicted in FIG. 1A, the second male terminal 104 may include a wire terminated female terminal 108 and a double-ended male slider terminal 110. In some embodiments, the second male terminal 104 may be a second connector portion of a second wire. In some embodiments, the first wire and the second wire may be Controller Area Network (CAN) high or CAN low wires.

In some embodiments, the second male terminal 104 may further include a connector position assurance device 112 disposed on the second male terminal 104. In some embodiments, the second male terminal 104 may be configured to be mechanically connectable to the first female terminal 102. As depicted in FIG. 1B, the first female terminal 102 and the second male terminal 104 may be mechanically connected, but the wire terminated female terminal 106 may still not be electrically connected to the double-ended male slider terminal 110. As a result, even while the first female terminal 102 and the second male terminal 104 appears to be connected, the first female terminal 102 and the second male terminal 104 are not in fact electrically connected.

In some embodiments, the connector position assurance device 112 may be spring-loaded. In such an embodiment, after the first female terminal 102 and the second male terminal 104 are mechanically connected, the connector position assurance device 112 may be moved to compress against a spring 114, where the first female terminal 102 and the second male terminal 104 may be verified as being electrically connected when the connector position assurance device 112 is compressed against the spring 114. As depicted in FIG. 1C, the wire terminated female terminal 106 may be configured to be electrically connected to the double-ended male slider terminal 110 when the connector position assurance device 112 is compressed against the spring 114.

In some embodiments, the connector position assurance device 112 may include a slider terminal having a switch. In such embodiments, the connector position assurance device 112 may be configured to be slidable along a top side of the second male terminal 104. A slider may be configured to be connected to the switch and the second male terminal 104. In such embodiments, when the switch is configured to move the slider such that the slider is connected to the first female terminal 102 and the second male terminal 104, the first female terminal 102 may be verified to be electrically connected to the second male terminal 104.

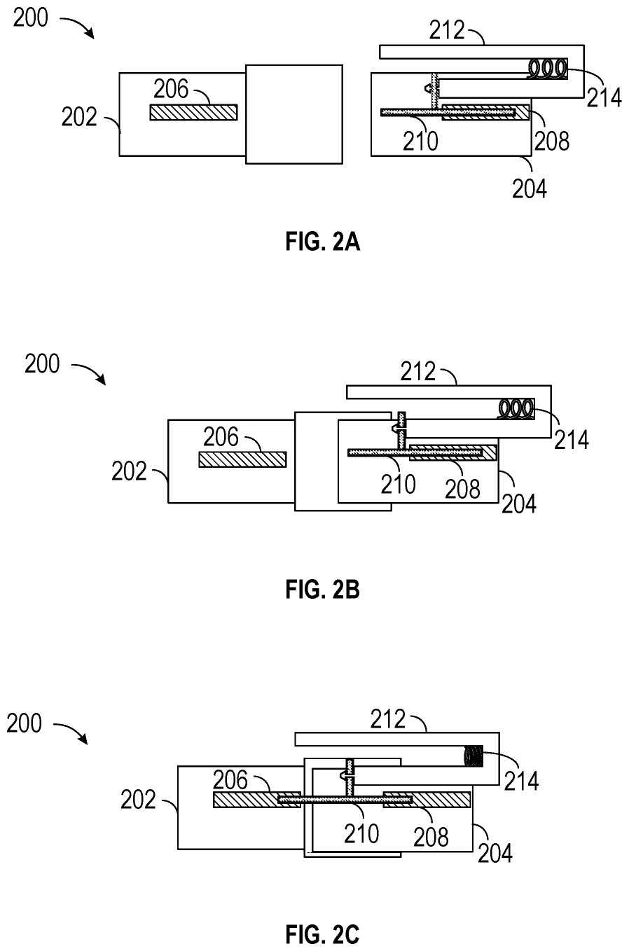

FIGS. 2A-C illustrates an example wiring connector 200 in accordance with an embodiment of the disclosure. In some embodiments, the wiring connector 200 may be a device connector or an inline connector. In some embodiments, the wiring connector 200 may be a sealed connector or an unsealed connector. In some embodiments, the wiring connector 200 may be an automotive connector. As depicted in FIGS. 2A-C, the wiring connector 200 may be a sealed inline connector. In some embodiments, the sealed inline connector may use a first female terminal 202 that is configured to be connected to a second male terminal 204. The sealed inline connector may be enabled by replacing one male blade with a female terminal in a male side connector. As depicted in FIG. 2A, the first female terminal 202 may include a wire terminated female terminal 206. In some embodiments, the first female terminal 202 may be a first connector portion of a first wire. As depicted in FIG. 2A, the second male terminal 204 may include a wire terminated female terminal 208 and a double-ended male slider terminal 210. In some embodiments, the second male terminal 204 may be a second connector portion of a second wire. In some embodiments, the first wire and the second wire may be Controller Area Network (CAN) high or CAN low wires.

In some embodiments, the second male terminal 204 may further include a connector position assurance device 212 disposed on the second male terminal 204. In some embodiments, the second male terminal 204 may be configured to be mechanically connectable to the first female terminal 202. In some embodiments, the connector position assurance device 212 may be designed to pass through a seal of the wiring connector 200 in order to engage the double-ended male slider terminal 210 when the first female terminal 202 is mechanically connected to the second male terminal 204. As depicted in FIG. 2B, the first female terminal 202 and the second male terminal 204 may be mechanically connected, but the wire terminated female terminal 206 may still not be electrically connected to the double-ended male slider terminal 210. As a result, even while the first female terminal 202 and the second male terminal 204 appears to be connected, the first female terminal 202 and the second male terminal 204 are not in fact electrically connected.

In some embodiments, the connector position assurance device 212 may be spring-loaded. In such an embodiment, after the first female terminal 202 and the second male terminal 204 are mechanically connected, the connector position assurance device 212 may be moved to compress against a spring 214, where the first female terminal 202 and the second male terminal 204 may be verified as being electrically connected when the connector position assurance device 212 is compressed against the spring 214. As depicted in FIG. 2C, the wire terminated female terminal 206 may be configured to be electrically connected to the double-ended male slider terminal 210 when the connector position assurance device 212 is compressed against the spring 214.

In some embodiments, the connector position assurance device 212 may include a slider terminal having a switch. In such embodiments, the connector position assurance device 212 may be configured to be slidable along a top side of the second male terminal 204. A slider may be configured to be connected to the switch and the second male terminal 204. In such embodiments, when the switch is configured to move the slider such that the slider is connected to the first female terminal 202 and the second male terminal 204, the first female terminal 202 may be verified to be electrically connected to the second male terminal 204.

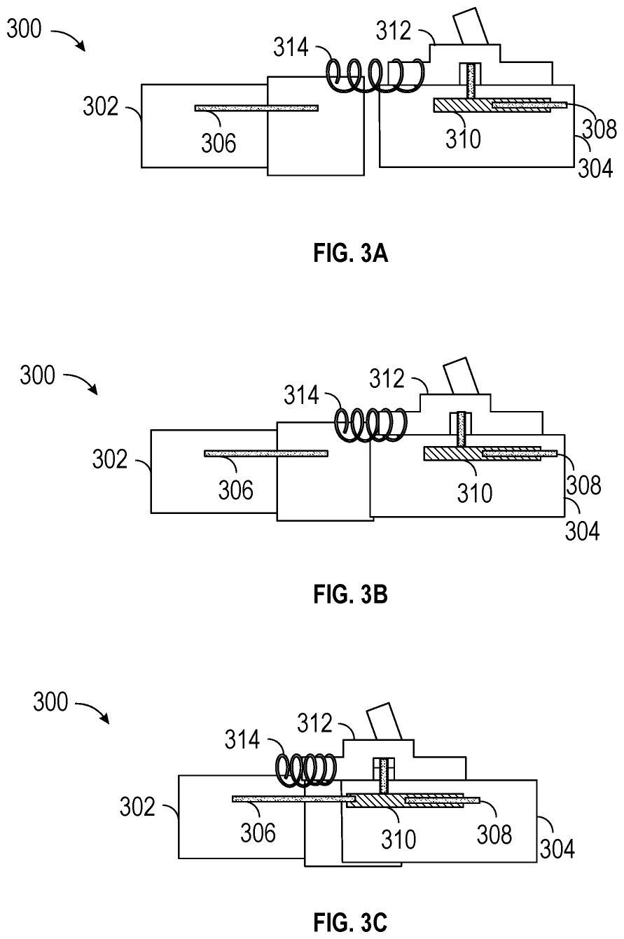

FIGS. 3A-C illustrates an example wiring connector 300 in accordance with an embodiment of the disclosure. In some embodiments, the wiring connector 300 may be a device connector or an inline connector. In some embodiments, the wiring connector 300 may be a sealed connector or an unsealed connector. In some embodiments, the wiring connector 300 may be an automotive connector. As depicted in FIGS. 3A-C, the wiring connector 300 may be an unsealed inline connector. In some embodiments, the unsealed inline connector may use a first female terminal 302 that is configured to be connected to a second male terminal 304. The unsealed inline connector may be enabled by replacing one male blade with a female terminal in a male side connector. As depicted in FIG. 3A, the first female terminal 302 may include a first double-ended male slider terminal 306. In some embodiments, the first female terminal 302 may be a first connector portion of a first wire. As depicted in FIG. 3A, the second male terminal 304 may include a second double-ended male slider terminal 308 and a wire terminated female terminal 310. In some embodiments, the second male terminal 304 may be a second connector portion of a second wire. In some embodiments, the first wire and the second wire may be Controller Area Network (CAN) high or CAN low wires.

In some embodiments, the second male terminal 304 may further include a connector position assurance device 312 disposed on the second male terminal 304. In some embodiments, the second male terminal 304 may be configured to be mechanically connectable to the first female terminal 302. As depicted in FIG. 3B, the first female terminal 302 and the second male terminal 304 may be mechanically connected, but the first double-ended male slider terminal 306 may still not be electrically connected to the wire terminated female terminal 310. As a result, even while the first female terminal 302 and the second male terminal 304 appears to be connected, the first female terminal 302 and the second male terminal 304 are not in fact electrically connected.

In some embodiments, the connector position assurance device 312 may be spring-loaded. In such an embodiment, after the first female terminal 302 and the second male terminal 304 are mechanically connected, the connector position assurance device 312 may be moved to compress against a spring 314, where the first female terminal 302 and the second male terminal 304 may be verified as being electrically connected when the connector position assurance device 312 is compressed against the spring 314. As depicted in FIG. 3C, the first double-ended male slider terminal 306 may be configured to be electrically connected to the wire terminated female terminal 310 when the connector position assurance device 312 is compressed against the spring 314.

In some embodiments, the connector position assurance device 312 may include a slider terminal having a switch. In such embodiments, the connector position assurance device 312 may be configured to be slidable along a top side of the second male terminal 304. A slider may be configured to be connected to the switch and the second male terminal 304. In such embodiments, when the switch is configured to move the slider such that the slider is connected to the first female terminal 302 and the second male terminal 304, the first female terminal 302 may be verified to be electrically connected to the second male terminal 304.

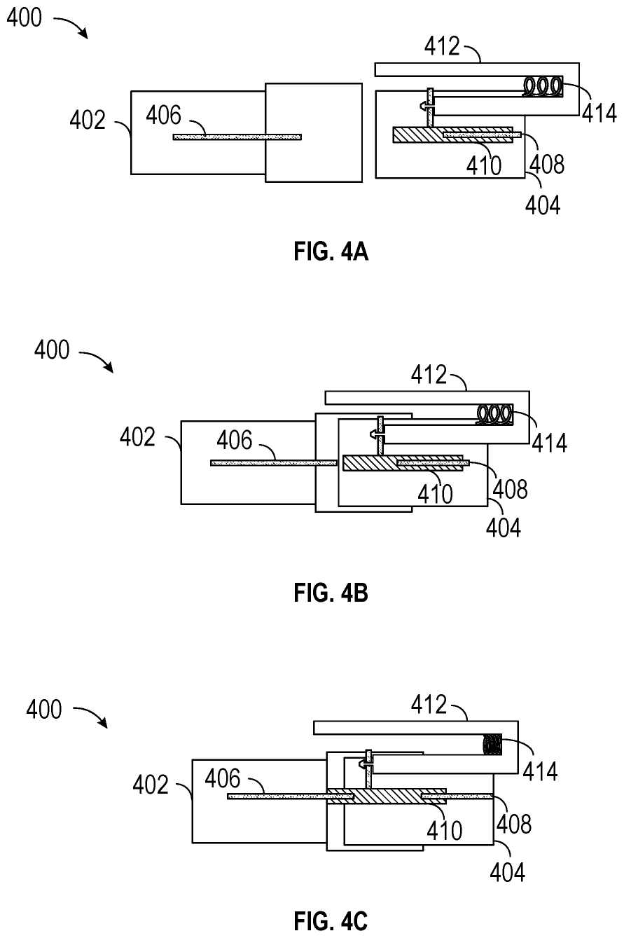

FIGS. 4A-C illustrates an example wiring connector 400 in accordance with an embodiment of the disclosure. In some embodiments, the wiring connector 400 may be a device connector or an inline connector. In some embodiments, the wiring connector 400 may be a sealed connector or an unsealed connector. In some embodiments, the wiring connector 400 may be an automotive connector. As depicted in FIGS. 4A-C, the wiring connector 400 may be a sealed device connector. In some embodiments, the sealed device connector may use a first female terminal 402 that is configured to be connected to a second male terminal 404. The sealed device connector may be enabled by replacing one female terminal with a male terminal in a female side connector. As depicted in FIG. 4A, the first female terminal 402 may include a wire terminated male terminal 406. In some embodiments, the first female terminal 302 may be a first connector portion of a first wire. As depicted in FIG. 4A, the second male terminal 404 may include a wire terminated male terminal 408 and a double-ended female slider terminal 410. In some embodiments, the second male terminal 404 may be a second connector portion of a second wire. In some embodiments, the first wire and the second wire may be Controller Area Network (CAN) high or CAN low wires.

In some embodiments, the second male terminal 404 may further include a connector position assurance device 412 disposed on the second male terminal 404. In some embodiments, the second male terminal 404 may be configured to be mechanically connectable to the first female terminal 402. In some embodiments, the connector position assurance device 412 may be designed to pass through a seal of the wiring connector 400 in order to engage the double-ended female slider terminal 410 when the first female terminal 402 is mechanically connected to the second male terminal 404. As depicted in FIG. 4B, the first female terminal 402 and the second male terminal 404 may be mechanically connected, but the wire terminated male terminal 406 may still not be electrically connected to the double-ended female slider terminal 410. As a result, even while the first female terminal 402 and the second male terminal 404 appears to be connected, the first female terminal 402 and the second male terminal 404 are not in fact electrically connected.

In some embodiments, the connector position assurance device 412 may be spring-loaded. In such an embodiment, after the first female terminal 402 and the second male terminal 404 are mechanically connected, the connector position assurance device 412 may be moved to compress against a spring 414, where the first female terminal 402 and the second male terminal 404 may be verified as being electrically connected when the connector position assurance device 412 is compressed against the spring 414. As depicted in FIG. 4C, the wire terminated male terminal 406 may be configured to be electrically connected to the double-ended female slider terminal 410 when the connector position assurance device 412 is compressed against the spring 414.

In some embodiments, the connector position assurance device 412 may include a slider terminal having a switch. In such embodiments, the connector position assurance device 412 may be configured to be slidable along a top side of the second male terminal 404. A slider may be configured to be connected to the switch and the second male terminal 404. In such embodiments, when the switch is configured to move the slider such that the slider is connected to the first female terminal 402 and the second male terminal 404, the first female terminal 402 may be verified to be electrically connected to the second male terminal 404.

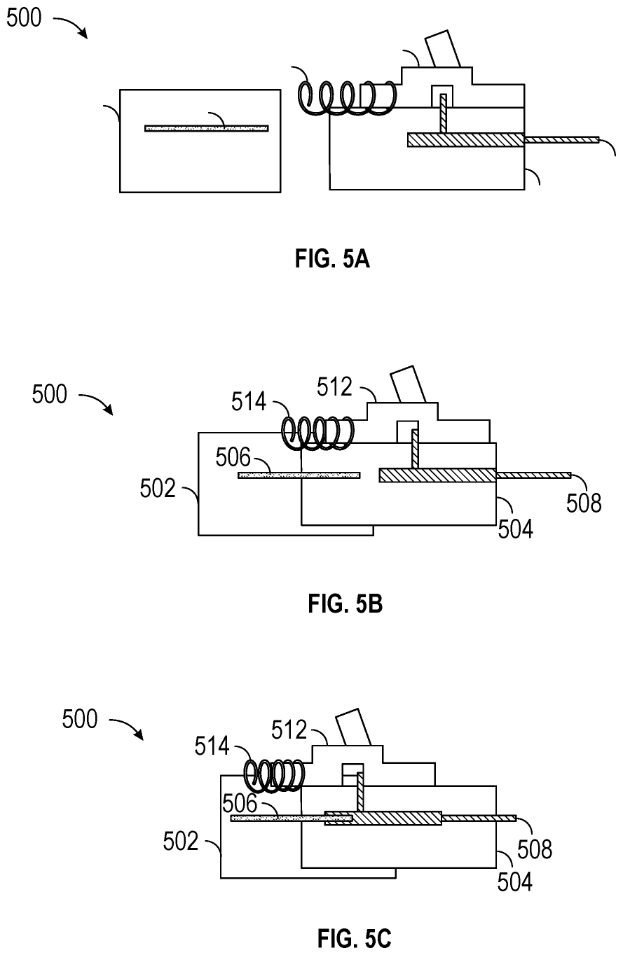

FIGS. 5A-C illustrates an example wiring connector 500 in accordance with an embodiment of the disclosure. In some embodiments, the wiring connector 500 may be a device connector or an inline connector. In some embodiments, the wiring connector 500 may be a sealed connector or an unsealed connector. In some embodiments, the wiring connector 500 may be an automotive connector. As depicted in FIGS. 5A-C, the wiring connector 500 may be an unsealed device connector. In some embodiments, the unsealed device connector may use a first female terminal 502 that is configured to be connected to a second male terminal 504. The unsealed device connector may use a wire terminated female terminal that is activated when a connector position assurance device is engaged. As depicted in FIG. 5A, the first female terminal 502 may include a wire terminated male terminal 506. In some embodiments, the first female terminal 502 may be a first connector portion of a first wire. As depicted in FIG. 5A, the second male terminal 504 may include a wire terminated female terminal 508. In some embodiments, the second male terminal 504 may be a second connector portion of a second wire. In some embodiments, the first wire and the second wire may be Controller Area Network (CAN) high or CAN low wires.

In some embodiments, the second male terminal 504 may further include a connector position assurance device 512 disposed on the second male terminal 504. In some embodiments, the second male terminal 504 may be configured to be mechanically connectable to the first female terminal 502. As depicted in FIG. 5B, the first female terminal 502 and the second male terminal 504 may be mechanically connected, but the wire terminated male terminal 506 may still not be electrically connected to the wire terminated female terminal 508. As a result, even while the first female terminal 502 and the second male terminal 504 appears to be connected, the first female terminal 502 and the second male terminal 504 are not in fact electrically connected.

In some embodiments, the connector position assurance device 512 may be spring-loaded. In such an embodiment, after the first female terminal 502 and the second male terminal 504 are mechanically connected, the connector position assurance device 512 may be moved to compress against a spring 514, where the first female terminal 502 and the second male terminal 504 may be verified as being electrically connected when the connector position assurance device 512 is compressed against the spring 514. As depicted in FIG. 5C, the wire terminated male terminal 506 may be configured to be electrically connected to the wire terminated female terminal 508 when the connector position assurance device 512 is compressed against the spring 514.

In some embodiments, the connector position assurance device 512 may include a slider terminal having a switch. In such embodiments, the connector position assurance device 512 may be configured to be slidable along a top side of the second male terminal 504. A slider may be configured to be connected to the switch and the second male terminal 504. In such embodiments, when the switch is configured to move the slider such that the slider is connected to the first female terminal 502 and the second male terminal 504, the first female terminal 502 may be verified to be electrically connected to the second male terminal 504.

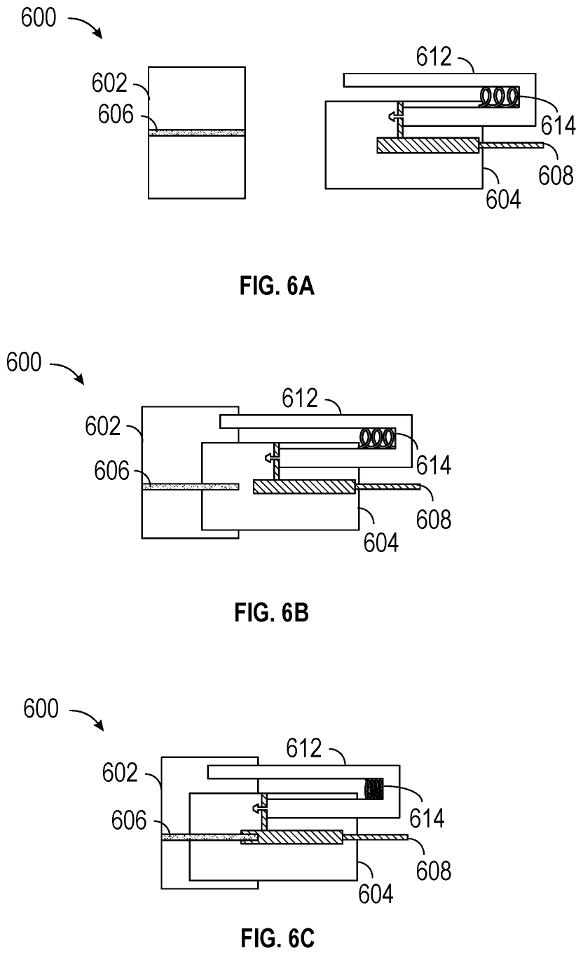

FIGS. 6A-C illustrates an example wiring connector 600 in accordance with an embodiment of the disclosure. In some embodiments, the wiring connector 600 may be a device connector or an inline connector. In some embodiments, the wiring connector 600 may be a sealed connector or an unsealed connector. In some embodiments, the wiring connector 600 may be an automotive connector. As depicted in FIGS. 6A-C, the wiring connector 600 may be a sealed device connector. In some embodiments, the sealed device connector may use a first female terminal 602 that is configured to be connected to a second male terminal 604. The sealed device connector may be enabled by using a wire terminated female terminal that is activated when a connector position assurance device is engaged. As depicted in FIG. 6A, the first female terminal 602 may include a wire terminated male terminal 606. In some embodiments, the first female terminal 602 may be a first connector portion of a first wire. As depicted in FIG. 6A, the second male terminal 604 may include a wire terminated female terminal 608. In some embodiments, the second male terminal 604 may be a second connector portion of a second wire. In some embodiments, the first wire and the second wire may be Controller Area Network (CAN) high or CAN low wires.

In some embodiments, the second male terminal 604 may further include a connector position assurance device 612 disposed on the second male terminal 604. In some embodiments, the second male terminal 604 may be configured to be mechanically connectable to the first female terminal 602. In some embodiments, the connector position assurance device 612 may be designed to pass through a seal of the wiring connector 600 in order to engage the wire terminated female terminal 608 when the first female terminal 602 is mechanically connected to the second male terminal 604. As depicted in FIG. 6B, the first female terminal 602 and the second male terminal 604 may be mechanically connected, but the wire terminated male terminal 606 may still not be electrically connected to the wire terminated female terminal 608. As a result, even while the first female terminal 602 and the second male terminal 604 appears to be connected, the first female terminal 602 and the second male terminal 604 are not in fact electrically connected.

In some embodiments, the connector position assurance device 612 may be spring-loaded. In such an embodiment, after the first female terminal 602 and the second male terminal 604 are mechanically connected, the connector position assurance device 612 may be moved to compress against a spring 614, where the first female terminal 602 and the second male terminal 604 may be verified as being electrically connected when the connector position assurance device 612 is compressed against the spring 614. As depicted in FIG. 6C, the wire terminated male terminal 606 may be configured to be electrically connected to the wire terminated female terminal 608 when the connector position assurance device 612 is compressed against the spring 614.

In some embodiments, the connector position assurance device 612 may include a slider terminal having a switch. In such embodiments, the connector position assurance device 612 may be configured to be slidable along a top side of the second male terminal 604. A slider may be configured to be connected to the switch and the second male terminal 604. In such embodiments, when the switch is configured to move the slider such that the slider is connected to the first female terminal 602 and the second male terminal 604, the first female terminal 602 may be verified to be electrically connected to the second male terminal 604.

In some embodiments, although not depicted in FIGS. 1A through 6C, a wiring connector (for example, wiring connector 100 in FIGS. 1A-C, wiring connector 200 in FIGS. 2A-C, wiring connector 300 in FIGS. 3A-C, wiring connector 400 in FIGS. 4A-C, wiring connector 500 in FIGS. 5A-C, and wiring connector 600 in FIGS. 6A-C) may be electrically connected by first aligning a first connector portion of a first wire against a second connector portion of a second wire. The first connector portion of the first wire may refer to a first terminal. The second connector portion of the second wire may refer to a second terminal. The first connector portion may then be moved towards the second connector portion. After the first connector portion is mechanically connected to the second connector portion, the first wire may be electrically connected to the second wire via a connector position assurance device.

In some embodiments, although not depicted in FIGS. 1A through 6C, a wiring connector (for example, wiring connector 100 in FIGS. 1A-C, wiring connector 200 in FIGS. 2A-C, wiring connector 300 in FIGS. 3A-C, wiring connector 400 in FIGS. 4A-C, wiring connector 500 in FIGS. 5A-C, and wiring connector 600 in FIGS. 6A-C) may be implemented in high voltage circuits. In some embodiments, the high voltage circuits may require a way to turn off the power to the circuits when disconnecting from a device. Using the wiring connector (for example, wiring connector 100 in FIGS. 1A-C, wiring connector 200 in FIGS. 2A-C, wiring connector 300 in FIGS. 3A-C, wiring connector 400 in FIGS. 4A-C, wiring connector 500 in FIGS. 5A-C, and wiring connector 600 in FIGS. 6A-C) to complete the high voltage circuits may allow a connector position assurance device in the wiring connector to break the high voltage circuit when the high voltage circuit is disconnected from a device. In some embodiments, disconnecting the high voltage circuit from a device may include notifying the device to turn off a high voltage source and powering down the high voltage circuit before any other circuits are disconnected.

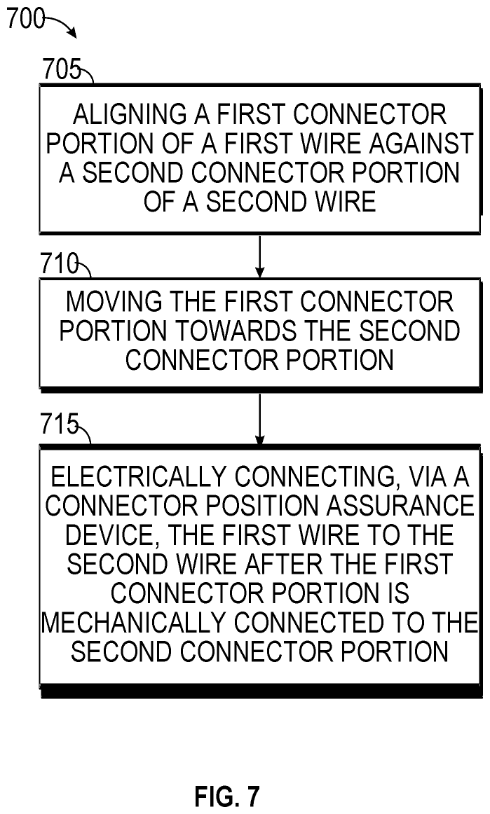

FIG. 7 shows a flow chart 700 of an example method of utilizing a wiring connector in accordance with the disclosure. The flow chart 700 illustrates a sequence of operations that can be implemented in hardware, software, or a combination thereof. The order in which the operations are described is not intended to be construed as a limitation, and any number of the described operations may be carried out in a different order, omitted, combined in any order, and/or carried out in parallel. Some or all of the operations described in the flow chart 700 may be carried out either independently or in cooperation with other devices such as, for example, other vehicle components.

At block 705, a first connector portion of a first wire may be aligned against a second connector portion of a second wire. In some embodiments, the first wire and the second wire may be disposed in either a device connector or an inline connector. In some embodiments, the first wire and the second wire may be disposed in either a sealed connector or an unsealed connector.

At block 710, the first connector portion may be moved towards the second connector position.

At block 715, the first wire may be electrically connected to the second wire via a connector position assurance device after the first connector portion is mechanically connected to the second connector portion. In some embodiments, the connector position assurance device may be spring-loaded. In some embodiments, the first wire may be electrically connected to the second wire when the connector position assurance device is compressed against a spring. In some embodiments, the connector position assurance device may comprise a slider terminal having a switch. In some embodiments, the connector position assurance device may further comprise a slider connected to the switch and the second connector portion, and wherein the first wire is electrically connected to the second wire when the switch is configured to move a slider such that the slider is connected to the first connector portion and the second connector portion.

In some embodiments, the first wire, the second wire, and the connector position assurance device may form a wiring connector in an electrical distribution system.

Some embodiments may be used in conjunction with various devices and systems, for example, a vehicle, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

It should be noted that the embodiments discussed above may be implemented in conjunction with hardware components, software components, firmware components, or any combination thereof to perform at least a portion of their functions. For example, a component may include electrical circuitry connected to an embodiment of a wiring connector. These example devices are provided herein for purposes of illustration and are not intended to be limiting. Embodiments of the present disclosure may be implemented in further types of devices, as would be known to persons skilled in the relevant art(s).

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey the information that certain embodiments could include, while other embodiments may not include, certain features, elements, and/or steps. Thus, such conditional language is not generally intended to imply that features, elements, and/or steps are in any way required for one or more embodiments.

That which is claimed is:

1. A system for making an electrical and mechanical connection in an electrical distribution system of a vehicle, the system comprising:
a first wire having a first connector portion;
a second wire having a second connector portion; and
a connector position assurance device configured to electrically connect the first wire to the second wire after the first connector portion is mechanically connected to the second connector portion.

2. The system of claim 1, wherein the connector position assurance device is spring-loaded.

3. The system of claim 2, wherein the first wire is electrically connected to the second wire when the connector position assurance device is compressed against a spring.

4. The system of claim 1, wherein the first wire and the second wire are disposed in either a device connector or an inline connector.

5. The system of claim 1, wherein the first wire and the second wire are disposed in either a sealed connector or an unsealed connector.

6. The system of claim 1, wherein the connector position assurance device comprises a slider terminal having a switch.

7. The system of claim 6, further comprising a slider connected to the switch and the second connector portion, and wherein the first wire is electrically connected to the second wire when the switch is configured to move the slider such that the slider is connected to the first connector portion and the second connector portion.

8. A method comprising:
aligning a first connector portion of a first wire against a second connector portion of a second wire;
moving the first connector portion towards the second connector portion; and
electrically connecting, via a connector position assurance device, the first wire to the second wire after the first connector portion is mechanically connected to the second connector portion.

9. The method of claim 8, wherein the connector position assurance device is spring-loaded.

10. The method of claim 9, wherein the first wire is electrically connected to the second wire when the connector position assurance device is compressed against a spring.

11. The method of claim 8, wherein the first wire and the second wire are disposed in either a device connector or an inline connector.

12. The method of claim 8, wherein the first wire and the second wire are disposed in either a sealed connector or an unsealed connector.

13. The method of claim 8, wherein the connector position assurance device comprises a slider terminal having a switch.

14. The method of claim 13, further comprising a slider connected to the switch and the second connector portion, and wherein the first wire is electrically connected to the second wire when the switch is configured to move the slider such that the slider is connected to the first connector portion and the second connector portion.

15. A vehicle comprising:
an electrical distribution system having a wiring connector comprising:
a first wire with a first connector portion;
a second wire with a second connector portion; and
a connector position assurance device configured to electrically connect the first wire to the second wire after the first connector portion is mechanically connected to the second connector portion.

16. The vehicle of claim 15 wherein the connector position assurance device is spring-loaded, and wherein the first wire is electrically connected to the second wire when the connector position assurance device is compressed against a spring.

17. The vehicle of claim 15, wherein the first wire and the second wire are disposed in either a device connector or an inline connector.

18. The vehicle of claim 15, wherein the first wire and the second wire are disposed in either a sealed connector or an unsealed connector.

19. The vehicle of claim 15, wherein the connector position assurance device comprises a slider terminal having a switch.

20. The vehicle of claim 19, further comprising a slider connected to the switch and the second connector portion, and wherein the first wire is electrically connected to the second wire when the switch is configured to move the slider such that the slider is connected to the first connector portion and the second connector portion.
